(19) United States
(12) Patent Application Publication
(10) Pub. No.: US 2024/0174036 A1
(43) Pub. Date: May 30, 2024

(54) Motor Vehicle Support Member With a Bushing

(71) Applicant: Kirchhoff Automotive Deutschland GmbH, Attendorn (DE)

(72) Inventors: Alexander Günther, Olpe (DE); Phil GRÜSSING, Finnentrop (DE); Jan Stuhrmann, Drolshagen (DE); Marc Horlacher, Attendron (DE)

(21) Appl. No.: 18/551,262

(22) PCT Filed: Mar. 22, 2022
(86) PCT No.: PCT/EP2022/057429

§ 371 Date: Sep. 19, 2023

(30) Foreign Application Priority Data
Mar. 22, 2021 (DE) 10 2021 107 065.1

(51) Int. Cl. B60D 1/56; B60D 1/48; B60R 19/24; B60R 19/48

(52) U.S. Cl. CPC B60D 1/565; B60D 1/485; B60R 19/24; B60R 19/48

(57) ABSTRACT

A motor vehicle support member 1 is described having a structured shell 5 having a wall W, into which wall 5 a recess is introduced, and having a bushing 4 held in the recess of wall 5 for receiving and/or mounting another component connectable thereto, wherein the recess has a conical collar 6, flared in the longitudinal direction of the bushing 4, as a receptacle for the bushing 4, to which the bushing 4 is fixed, wherein the bushing 4 includes a conical lateral surface 7 in the section in which it is fixed to the collar (6, 6a . . . 6f). A method for producing such a support member 1 is also described.

The invention relates to a motor vehicle support member having the features of the preamble of claim 1.

Support members are used for different purposes in motor vehicles: in the substructure, for example to mount or fix vehicle axles, as crossbeams in the area of the dashboard, as bumper crossbeams, etc. Single-shell or multi-shell support members are used for these purposes. In many cases, such support members are formed sheet steel components. Bushings for accommodating and/or mounting another component, such as an axle, a screw connection, or the like, are sometimes connected to such support members. If the support member is a bumper crossbeam, such a bushing is designed as a towing sleeve.

Single-shell support members of this type have two legs spaced apart by a wall, the end sections of which are typically flared outwards away from each other so that such a profile has a hat-shaped cross section. In the case of a two-shell design of such a support member, a closing plate, for example, is used as a further shell in order to close the hollow chamber of the first shell.

In the case of a two-shell support member, these have recesses on the opposite walls in the region of the bushing, through which the component to be mounted and/or accommodated extends. The recesses are typically arranged in the shells in such a way that they are at least largely aligned with one another transversely to the longitudinal extension of the support member. The bushing engages in the recesses and is welded to them. Their longitudinal extension is therefore essentially aligned with the axis of the recesses in the shells. In order that transverse forces and bending moments can be absorbed by the bushing and introduced into the support member, the walls of the shells for mounting the bushings are spaced apart from one another; they enclose a volume. In many cases, such a support member is a hollow-chamber profile support member formed by the shells. In the case of a single-shell design of the support member, a support element having a second recess is located in the cavity of the support member, so that in such a case the bushing is also connected to the support member at two points spaced apart from one another.

DE 10 2005 056 578 B4 discloses a bumper crossbeam having a bushing as a towing sleeve into which a towing eye can be inserted. The bushing is mounted on both shells of the support member in or on opposite walls, in that the bushing extends through one shell and abuts the other shell and is welded to it.

A similar configuration is shown in DE 10 2019 124 020 A1, DE 44 37 177 A1, and US 2012/0 292 930 A1. In these documents, a recess is introduced into a wall of a support member, in which a bushing is inserted as a towing sleeve.

The recesses are punched out of the respective wall of the shell. The bushing extends through the respective recess in order to form a welding fillet. Both components—shell and liner—are MIG or MAG welded in this fillet. Laser welding of bushing and shell to form such a support member is not possible due to the possible narrow formation of a weld seam. The weld seam would not meet the mechanical requirements placed on it. In addition, the notch effect in such a weld seam is high. With the MIG or MAG welding processes used, a relatively large heat influence zone forming is accepted, which naturally has an influence on the strength of the joining partners in the areas adjacent to the weld seam: A large part of the—actually desired—ductility of the joining partners is lost, so that jerky impacts or lateral forces in particular can be absorbed more poorly.

Against this background, the invention is based on the object of proposing a fastening of a bushing to a shell for forming a support member, for example a bumper crossbeam, in which not only impacts and transverse forces/bending moments can be better absorbed, but in which the bushing can in principle also be attached without additional further support measures on the wall of a single shell, meeting the requirements.

This object is achieved by a generic motor vehicle support member mentioned at the outset and having the features of claim 1.

Advantageous embodiments of the invention result from the dependent claims and the following description.

Support members designed in this way can be, for example, bumper crossbeams, axle support members, subframes, or the like. These support members can be open or closed support members.

In the latter case, these are in many cases constructed from two or more shells. In the case of a single-shell support member, a support member property results from its structuring, for example in that it has a U-shaped or hat-shaped profile.

With such a design of the motor vehicle support member, the lateral surface of the bushing and the recess engage in one another in a complementary manner. Due to the complementary conicity of the two components, the bushing is held in such a recess not only in a form-fitting but also in a force-fitting manner, so that these two types of connection complement each other accordingly. This motor vehicle support member uses the fact that the collar has been flared by forming, as a result of which it undergoes a certain strain hardening in its bending zone. The result is that transverse forces introduced via the bushing are not only coupled into the front side of the wall of a shell with the weld seam interposed, as is the case with previously known support members of this type, but also into the flat side provided by the flaring of the collar and that transverse forces introduced due to the forming of the collar as a result of the strain hardening are introduced into the shell distributed over a greater extension in the circumferential direction. To further increase this effect, the collar can be located inside or as part of a bead or other structure-reinforcing indentation or embossing introduced into the wall having the recess.

A further advantage is that the conical design of the two joining partners to be connected allows tolerance compensation, to the extent that the lateral surface of the bushing and the inner surface of the collar touch. This achieves a self-centering of the bushing within the recess. Tolerances in the longitudinal extension of the bushing or in the distance of the walls of the shells in the case of a two-shell design of the support member are therefore easily compensated for, so that it is ensured that the bushing contacts the collars of the shells in the region of its connection sections.

In the sense of these statements, any tapering shape is ultimately to be understood as being conical. The geometry of the base surface is not relevant to the implementation of the invention. It is preferably provided that the base surface is round, a cone or truncated cone shape is then provided. Such a form is easy to produce.

The collar protrudes from the plane of the wall of the shell and, because of its conical configuration, continuously changes its cross-sectional area in the longitudinal direction of its opening direction. Depending on the design, the change can be tapering or expanding. This depends on the direction in which the collar is flared and from which direction the bushing is to be mounted. The flare of the collar may be flared outwards or inwards with respect to the outside of the support member. An embodiment is also possible in which the collar tapers in both directions, forming a peak or a peak region that forms the constriction of the recess. The bushing also has a conical lateral surface, at least in one section, which is why the above statements also apply to the lateral surface of the bushing.

This special design of the recess with its flared collar makes it possible for the first time to join a bushing in such a recess by laser welding or, for example, by adhesive bonding. With laser welding, the flared collar provides a sufficient reservoir of material, even with thin-walled shells, so that the collar can be laser welded to the bushing without accepting the risk of the laser beam burning holes. The laser welding is preferably carried out without welding allowance. This is basically also not necessary due to the welding reservoir created by the flared collar.

In the case of a welded connection between the two joining partners—bushing and collar—it is useful if the design of the angle of inclination of the conical lateral surface and the contour of the flared collar are coordinated with one another in such a way that a gap opening with respect to the gap width is formed between the collar and the bushing on the side facing away from the welding energy.

The conical design of the collar and that of the bushing in its section contacting the collar can also be used to form a recessed fillet for receiving molten welding material. As a result of the conicity, at least one circumferential line contact is settable between the two joining partners, so that such a weld fillet is closed and is therefore also suitable for receiving low viscosity molten welding material, as is the case with aluminum welding, for example if the two components are MIG or MAG welded. In such a design, it is advisable if the taper of the flared collar and lateral surface of the bushing are designed in opposite directions, wherein the collar is flared inwards towards the support member interior.

For the purposes of laser welding, it is expedient if the taper angle of the collar and that of the lateral surface of the bushing are designed in relation to one another in such a way that that of the collar is not smaller than that formed by the lateral surface of the bushing; it is therefore greater than or equal to the taper angle formed by the lateral surface of the bushing. This means that the receptacle formed by the collar tapers more sharply in its opening direction than the lateral surface of the bushing. Even if such a design is expedient for laser welding of bushing and collar, the taper angles can also be the same or the taper angle of the lateral surface of the bushing can be greater than that of the collar.

The collar of the shell can be produced inexpensively by embossing or deep drawing when producing the recess in the metal sheet, typically after a recess has been punched beforehand. The flared collar merges into the adjacent areas of the shell via a curved transition section. Such a radius additionally cushions a transverse load caused by a transverse force or a bending moment; this is supported by local hardening due to the production process.

Due to the described design of the collar of the shell and the contact thus provided of the lateral surface of the bushing, such a bushing, held solely in the wall of a shell, can absorb the forces required for numerous applications and introduce them into the shell. In contrast to previously known support members, this measure means that a second bearing or connection point is basically not required, which is particularly advantageous in the case of support members designed as single-shell.

In principle, the tolerance compensation advantages can also be achieved with such a support member if the bushing is fixed to the shell by a lock nut, using which the lateral surface of the bushing is drawn into the receptacle formed by the collar and supported against the collar. In this way, a detachable connection between the shell and the bushing can be established. Alternatively or additionally, the bushing can be adhesively bonded in the receptacle formed by the collar. However, it is preferably provided that the bushing is fixed to the collar by welding, in particular by laser welding, as shown above. This offers the advantage of a particularly durable and solid connection. The bushing can be held on the support member in a materially bonded, form-fitting, and friction-locked manner by welding.

Another advantage of a laser welded connection between the collar of the shell and the bushing is that the joint depth (weld seam depth) can be controlled particularly well and weld seams having a high welding depth can be implemented—due to the flared collar in particular without additional wire. Therefore, particularly high forces can be introduced from the bushing into the shell or absorbed by the shell. Preferably, the surfaces of the two joining partners—the collar of the shell and the lateral surface of the bushing—are formed in relation to one another with respect to their taper and their respective taper angle so that an opening gap is formed on the joining energy, for example on the side facing away from the laser beam. The degassing products produced by this during welding, in particular those of a corrosion-inhibiting coating, such as a zinc coating of the shell, are conducted away from the weld pool via this pathway. The quality of the weld seam is therefore not impaired by degassing processes. The laser welding method is preferably carried out with such a design of the joining partners in such a way that molten metal is introduced into the opening gap on the side facing away from the laser beam and fills it in the region of its root. This not only achieves a particularly high welding depth. Rather, a gap base is formed by the flow of the melt into the gap. The width of the gap base and thus the minimum gap width will be designed in such a way that a coating applied in liquid form, for example a cathodic dip coating, wets the entire surface of the gap and therefore no non-wetted spandrels remain. This also prevents capillary effects that could cause moisture to reach the weld seam.

In order to improve such welding, it can be provided that the collar contacts the lateral surface of the bushing along a line. In this way, the weld root can propagate into the gap when the welding process is performed with a laser beam centered on the joint of the collar and/or the bushing. The molten material is then brought into the gap by the butt joint.

In this context, it can be provided that the bushing and the collar do not end flush, so that an offset is formed between the joints of the collar and the bushing. The bushing preferably extends through the collar and protrudes in relation thereto. In this way, in particular during laser welding, the bushing, which typically has a greater material thickness than the collar, can be used as a weld pool support, while the joint of the flared collar is melted off during the welding process and, using the material thus provided, the gap between the lateral surface of the bushing and collar is filled with the melted material, as stated above. In such welding, the geometric center of the laser beam is directed at the joint of the collar, so that the required metal is melted off of it. For the purposes of providing weld pool support by way of the lateral surface of the bushing, it is sufficient if the bushing projects a few millimeters, such as 2 mm or 3 mm, in relation to the collar.

It is also possible for the collar to make planar contact with the lateral surface of the bushing in a contact area. Particularly in the case of laser welding, particularly when the joining partners are steel components, it can be provided that the surface in the longitudinal direction of the bushing is at most twice the material thickness of the thinner joining partner, typically the collar. Parts of the joining partners that flatly abut one another before welding are melted by the welding process and can thus sufficiently fill the gap. If the joining partners are components made of aluminum, the surface contact can also be more pronounced. Subsequent anti-corrosion coating is not required for such joining partners. Also, capillary effects do not result in detrimental corrosion phenomena.

For a uniform introduction of force from the bushing into the support member and to simplify any welding process, it can be provided that the collar contacts the bushing circumferentially.

In an alternative embodiment it is provided that the bushing and/or the collar have spacers which only allow the two surfaces to touch one another in sections in the circumferential direction. This can be achieved in that the bushing has, in the area in which it contacts the collar, rib-like thickenings on its lateral surface which extend in the longitudinal direction of the bushing and using which it contacts the collar. Another possibility, which can also be additionally provided, is for the collar to have rib-like thickenings extending in the longitudinal direction of the bushing in the region in which it contacts the lateral surface of the bushing, using which it contacts the lateral surface of the bushing. In this way, a gap is set between the bushing and the collar in the areas where no thickening is arranged. The gaps can then also be filled with weld pools using welding processes other than laser welding, for example MIG or MAG welding, so that in this way the bushing is mounted on the support member, but at the same time it is possible to fill the gap that enlarges on the side facing away from the welding, so that it is 0.2 mm and larger on the rear side.

It is preferably provided that the collar is flared outwards relative to the volume enclosed by the support member. Furthermore, it is preferably provided that the collar tapers in the recess in the direction pointing away from the volume enclosed by the support member. This is particularly advantageous when the bushing is primarily subjected to a tensile or compressive load, since in this way the bushing is pulled more strongly into the collar under load and is thus supported.

Such a support member can be designed with two shells, wherein it is sufficient if only one of the two shells has a recess, as described above, in which the bushing is fixed.

In a preferred exemplary embodiment, however, it is provided that the connection between the bushing and the shell described above is provided for both shells of the support member. The recesses of both shells then have a conical collar flared in the longitudinal direction of the bushing. In the areas in which it is fixed to the collar, the bushing has lateral surfaces that are complementary and conical in the same direction as the respective collar. In any case, the taper angles of the receptacles formed by the collars are not smaller than the respective taper angles formed by the lateral surface of the bushing. It is apparent that with such an embodiment, the taper angles formed by the collar and those of the bushing can definitely be different in the two walls located opposite to one another at a distance.

In order to withstand tensile and compressive loads in particular, it is advantageous if the directions in which the collars of the two shells are flared are in opposite directions. It is also advantageous if both collars are flared in a way that points away from the volume enclosed by the support member. In this way, the bushing is held in the manner of an X-bearing.

Another possibility is that the bushing is mounted on one hand on one shell by the conical mounting described above and on the other hand is mounted on the other shell in that it extends through the recess arranged therein without this recess having a collar and rests with a shoulder against the edge area of the recess. In this way it is possible to avoid tensions being introduced into the support member as a result of the assembly and any tolerances. Nevertheless, the effect with respect to absorbing transverse forces by appropriately adjusting the distance between the two shells in the area where the bushing is mounted is sufficient for many purposes.

According to one exemplary embodiment, it is provided that the support member has a two-shell design and is formed from a hat profile and a closing plate. Both shells are typically made from steel blanks. Such a support member is particularly stable and can absorb the necessary forces from the bushing. At the same time, these two parts are easy and inexpensive to produce; any hardening methods can also be carried out easily.

An advantageous application for such a motor vehicle support member is a bumper crossbeam having a bushing for connecting a towing eye. Especially with a towing eye, considerable forces, typically the entire weight of a vehicle, can occur, especially when starting off. However, the form fit formed between the bushing and the at least one shell readily absorbs these forces. The transverse forces can also be considerable, for example when cornering, but are introduced into the shells via the collar or collars. The weld seams themselves are therefore only subject to a small amount of stress.

To produce the motor vehicle support member described above, the following steps are typically carried out:
providing a shell having two legs spaced apart by a wall,
introducing at least one recess into the wall and forming a flared collar enclosing the recess,
installing a bushing engaging in the recesses, and
materially bonding the bushing with the collar of the shell.

This method can also be used to form a two-shell support member. A second shell is then provided having a corresponding recess, preferably also having a flared collar. In such a design, it is typically provided that in the course of mounting and thus before the connection of the two shells, the bushing is welded to at least one of the two shells. For this purpose, if the bushing is to be mounted on both shells, it can be provided that the bushing is held between the two shells and the two shells are clamped together by means of a clamping device. The bushing is then welded to the shells. Finally, the two shells are connected to each other. In this way, any tolerances relating to the recess and/or the collar and the lateral surface of the bushing are compensated for. This can be provided in particular with regard to the permissible tolerance with regard to the distance of the two half-shells. This is particularly advantageous when the two shells are connected with a certain overlap or are welded using a welding process, such as a MIG or MAG welding process, while the bushing is to be exactly laser welded due to the greater local introduction of force and the accompanying increased demands with respect to the mechanical properties.

The invention is explained in more detail hereinafter with reference to the appended figures. In the figures:

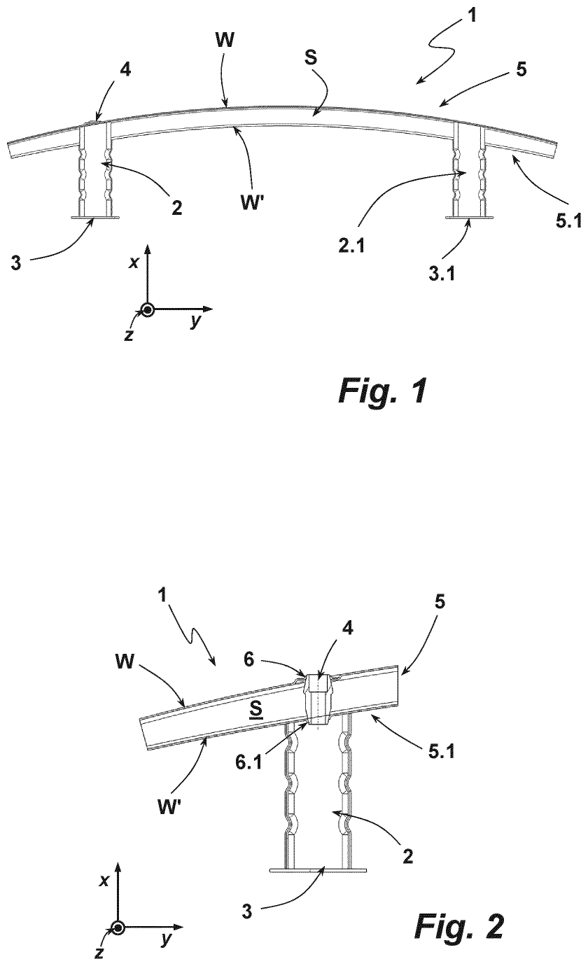

FIG. 1: shows a two-shell bumper crossbeam as an example of a motor vehicle support member in a top view,

FIG. 2: shows an enlarged cross section through the left part of the bumper crossbeam of FIG. 1 to show a towing sleeve integrated into the bumper crossbeam,

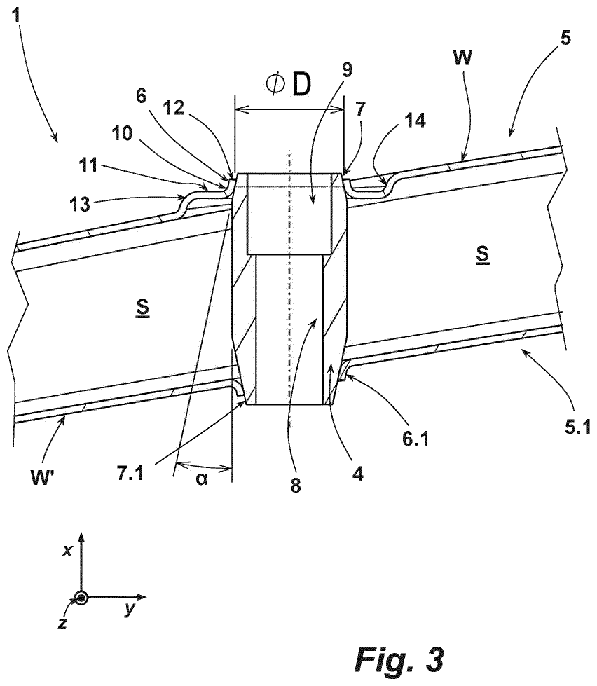

FIG. 3: shows an enlarged detailed view of the section according to FIG. 2.

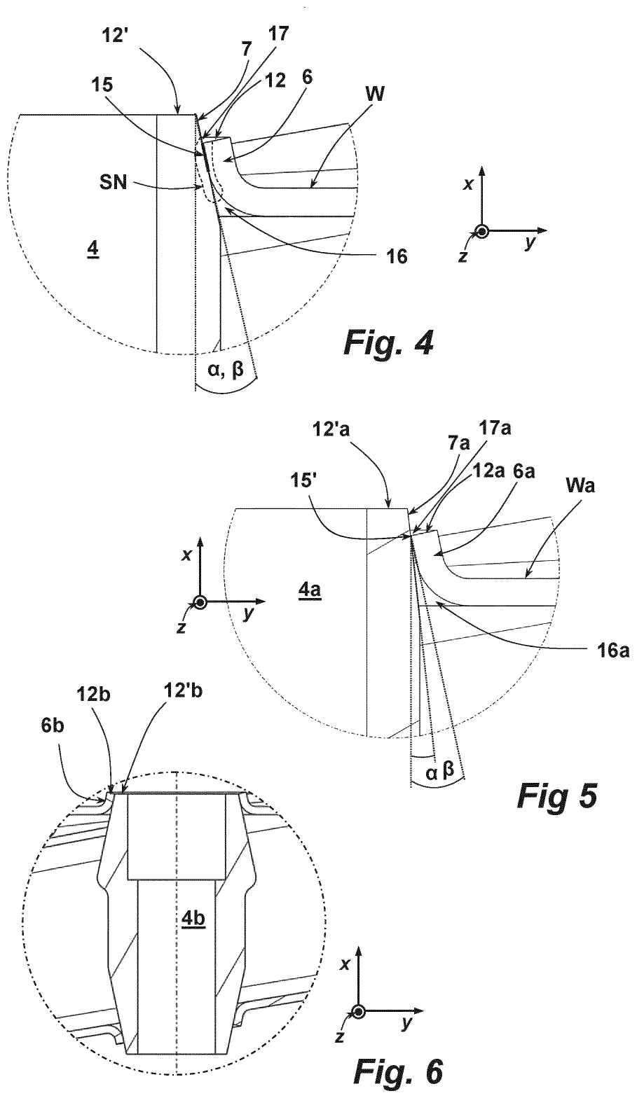

FIG. 4: shows a detailed view of a recess bordered by a collar for receiving a section of the towing sleeve according to a first exemplary embodiment,

FIG. 5: shows a detailed view of a recess bordered by a collar for receiving a section of the towing sleeve according to a second exemplary embodiment,

FIG. 6: shows a detailed view of a recess bordered by a collar for receiving a section of the towing sleeve according to a third exemplary embodiment,

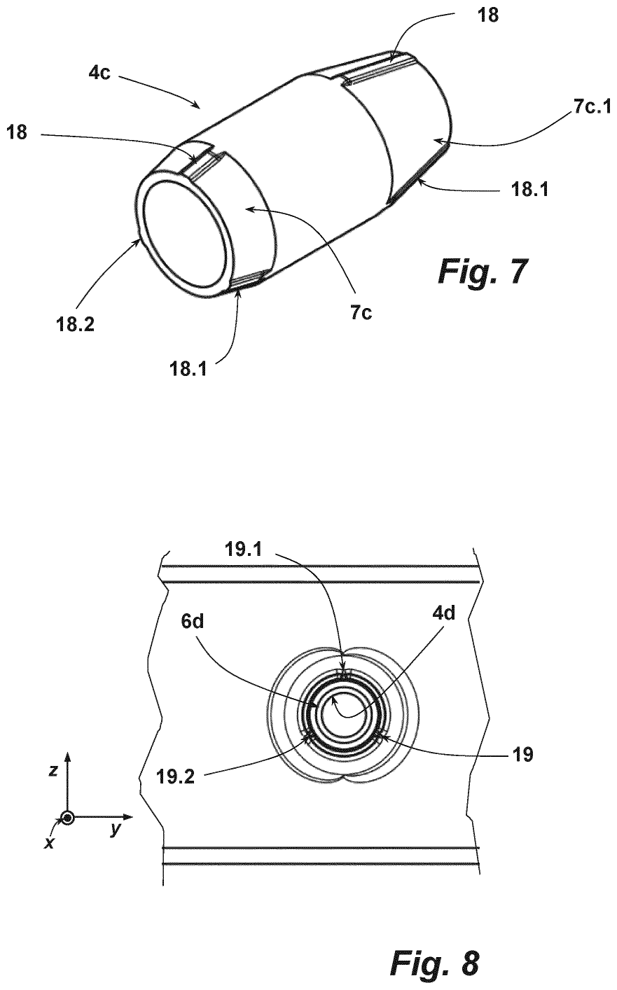

FIGS. 7/8: show examples of towing sleeves having alternatives in the design of the lateral surface of the bushing (FIG. 7) and the collar (FIG. 8),

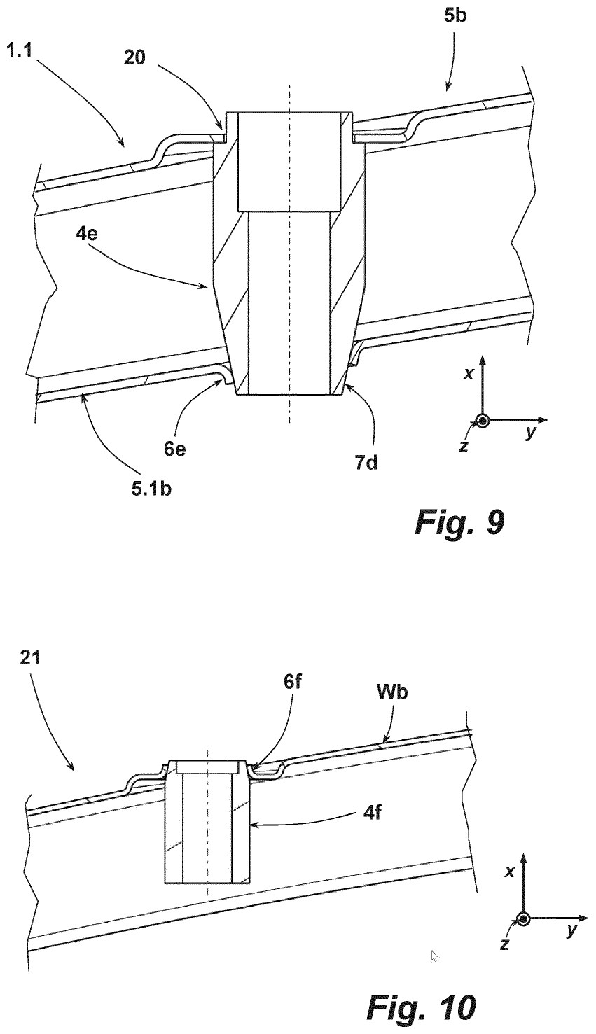

FIG. 9: shows a detailed view of a further bushing as a towing sleeve, which is mounted on two shells of a bumper crossbeam,

FIG. 10: shows a horizontal longitudinal sectional view through a section of a single-shell bumper crossbeam as an example of a motor vehicle support member,

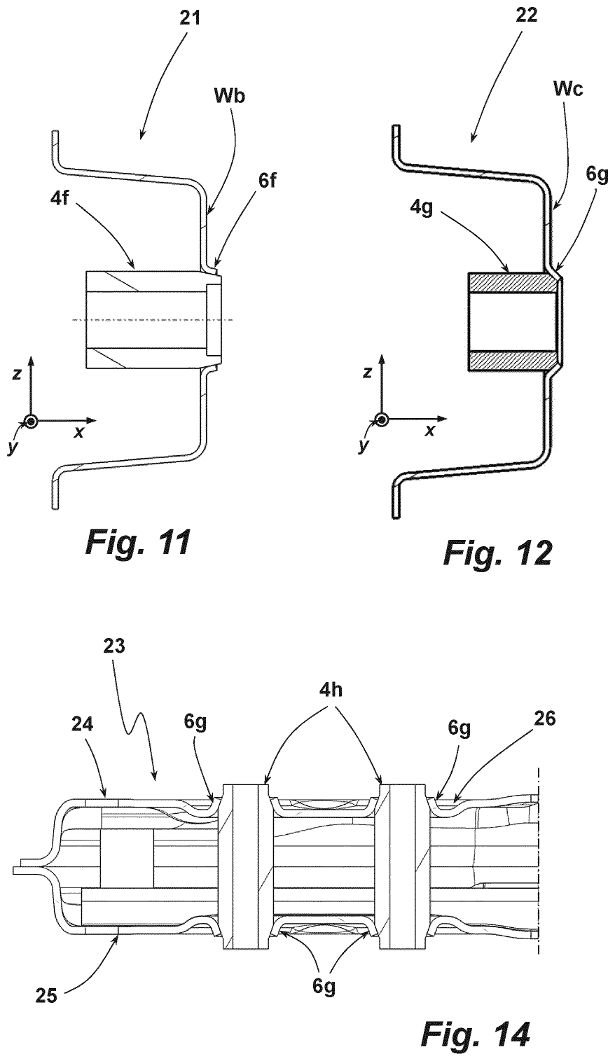

FIG. 11: shows a vertical sectional view through the bumper crossbeam of FIG. 10,

FIG. 12: shows an illustration of a further single-shell bumper crossbeam having a towing sleeve connected thereto as a bushing according to a further exemplary embodiment in a vertical section corresponding to that of FIG. 11,

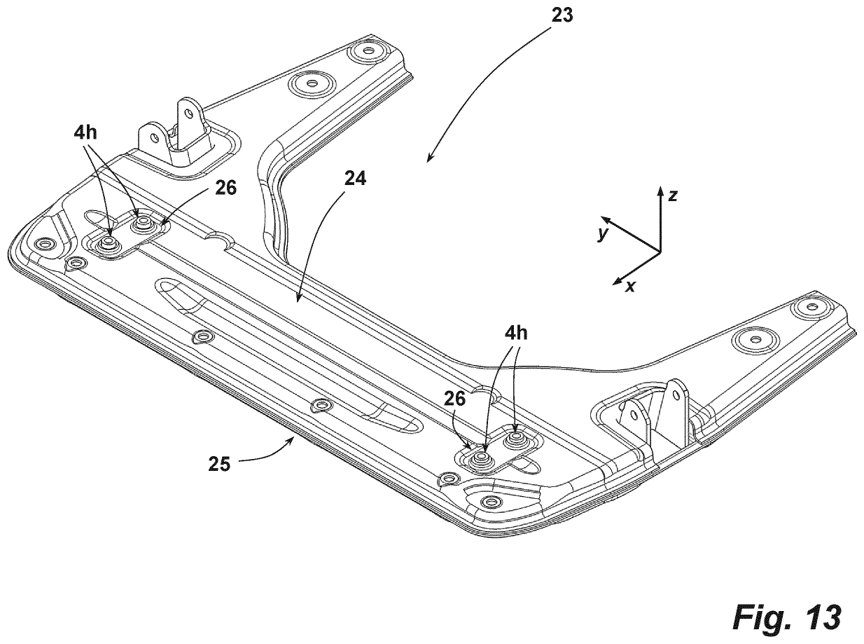

FIG. 13: shows a perspective representation of a support member designed as an auxiliary frame having multiple bushings,

FIG. 14: shows a partial sectional view through the support member of FIG. 13 in the area of two adjacent bushings,

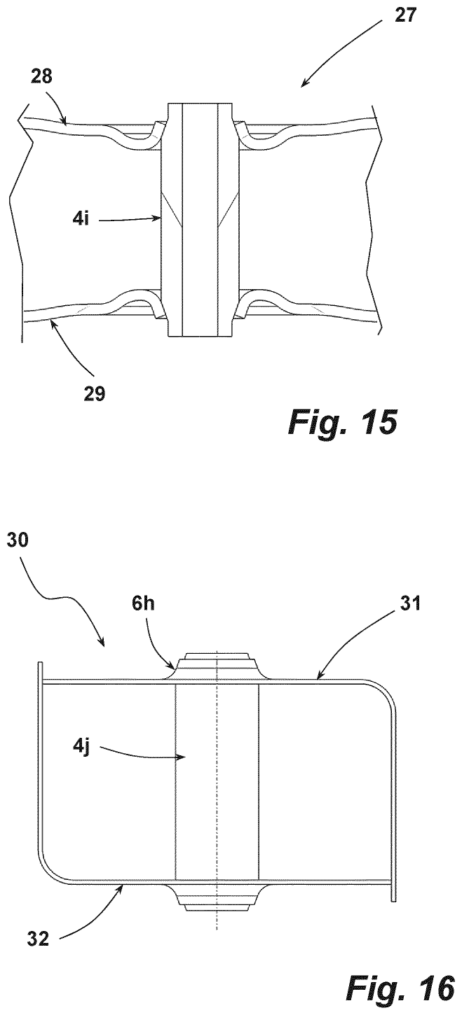

FIG. 15: shows a further two-shell support member having a bushing connecting the shells in a sectional view, and

FIG. 16: shows an end view of a further double-shell support member.

FIG. 1 shows a motor vehicle support member 1, designed here as a bumper crossbeam, which is connected to crash boxes 2, 2.1. The crash boxes 2, 2.1 each have base plates 3, 3.1, using which the crash boxes 2, 2.1 are connected to a chassis (not shown in more detail) of a motor vehicle, for example a passenger vehicle.

The support member 1 has a bushing 4 protruding only with a short section at the front in FIG. 1 as a towing sleeve for accommodating and/or mounting a further component, here: a towing eyelet (not shown in more detail).

FIG. 2 shows a horizontal section (section in the x-y plane) through the left part of the assembly shown in FIG. 1. The crash box 2 and the base plate 3 connected to it can be seen. The support member 1 is constructed from two shells 5, 5.1. The first shell 5 is a closing plate closing the second shell 5.1, which is designed as a hat profile. At this point, however, an arrangement is also conceivable in which the two shells 5, 5.1 are reversed in the vehicle longitudinal extension (x-direction). The second shell 5.1 comprises a wall W, by which the two legs S of the hat profile—the shell 5.1—are spaced apart. To form the support member 1, the shells 5, 5.1 are welded to one another on the longitudinal side along the flanges pointing away from one another. As a result of this design of the support member 1, it has two walls W, W′ which are arranged at a distance from one another. Between the two shells 5, 5.1, the bushing 4 is mounted in recesses introduced into the opposite walls W, W′, each of which has a collar 6, 6.1 that points away from the volume enclosed by the support member 1.

FIG. 3 shows the detail described above and the mounting of the bushing 4 in the walls W, W′ of the shells 5, 5.1 in an enlarged view. The recesses introduced into the walls W, W′ are each bordered by a flared collar 6, 6.1, each of which forms a receptacle into which the bushing 4 engages and is mounted. The two collars 6, 6.1 are flared in opposite directions in the x-direction.

The collars 6, 6.1 are conically shaped with respect to their lateral surface; in this exemplary embodiment, the base surface is circular. The cross-sectional area of the receptacles tapers towards the joint of the collars 6, 6.1.

In the region of its mounting on the walls W, W′, the bushing 4 has conical tapered lateral surfaces 7, 7.1. The tapers of these lateral surfaces 7, 7.1 taper with a taper angle α in the same direction and thus in the same way as the collars 6, 6.1.

In this exemplary embodiment, the bushing 4 comprises a threaded section 8 and a thread-free supporting section 9 in its interior for receiving a towing eye (not shown in more detail). The towing eye is screwed into the internally threaded section 8 with its threaded shaft. In order to be able to better absorb lateral forces that can occur when towing, particularly when turning or cornering, the towing eye is supported in the supporting section 9 in the radial direction by a supporting section that fits therein.

If there is a sudden tensile load, such as a sudden start-up process, a force moment is introduced into the bushing 4 in the x-direction. The conical arrangement of the collar 6 and the lateral surface 7 provides a form fit. The force introduced is divided into a y-component and an x-component. Due to the radius 10 in the transition between the relevant plane 11 of the wall W and the joint 12 of the flared collar 6, the force in the x-direction in particular is somewhat cushioned over its sudden time curve. In this way, the impact is introduced into the shell 5 more uniformly, both in terms of area and in terms of time.

This behavior is improved by beads 13, 14 additionally introduced into the front shell 5, by which the receptacle formed by the collar 6 is aligned essentially orthogonally to the longitudinal direction of the bushing 4 (in the y-z directions).

FIG. 4 shows the contact between the lateral surface 7 of the bushing 4 and the collar 6 in a detail view. The lateral surface 7 of the bushing 4 in this exemplary embodiment has the same taper angle α in the area of the mounting in the collar 6 as the collar 6 (taper angle β). In this way, a planar contact is provided along the contact area (indicated by 15 in FIG. 4). On the side facing away from the joint 12 there is a gap 16 which increases in terms of its opening width due to the curvature of the collar 6.

The arrangement shown in FIG. 4 is suitable for laser welding of the two components—shell 5 and bushing 4.

The welding beam is directed with its geometric center onto the joint 12 in the immediate vicinity of the joint in the fillet 17 between the lateral surface 7 and the section of the collar 6 abutting it, wherein the angle between the lateral surface 7 and the welding beam is between 1° and 45°. preferably 1° and 20°. Here the surface with which the collar 6 abuts the lateral surface 7 of the bushing 4 is as long in the direction of the longitudinal axis of the bushing 4 as the materially weaker joining partner, here the collar 6, is thick. The welding method is carried out in such a way that, in the welding configuration shown in this figure, only or largely only the joint 12 of the collar is somewhat melted off during the welding process. Part of the laser beam is also directed at the joint between the two joining partners. The weld seam extends along the depth of the joint up into the gap 16. The material melted off of the joint 12 of the collar 6 is available to fill the opening gap 16 in the region of its root on the side facing away from the energy input to such an extent that a gap base is formed. The width of the gap base and thus the minimum gap width of the gap 16 is designed to be sufficiently large so that the gap 16 having its gap base can be wetted circumferentially by a corrosion-inhibiting coating. The minimum gap width is approximately 0.2 mm. A subsequent CDC coating can then also be applied in this area without any problems, without having to worry that parts of the gap root will not be wetted due to the viscosity of the dip coating liquid.

The weld seam is schematically plotted by dashed lines in FIG. 4 with the reference sign SN.

An alternative embodiment of a contact of a bushing 4a on a collar 6a flared from a wall Wa of a shell of a support member corresponding to support member 1 is shown in FIG. 5. It can be seen that the taper angle β of the collar 6a is greater than that of the lateral surface 7a of the bushing 4a in the area of the mounting (taper angle α). As a result, a line contact (indicated by 15′ in FIG. 5) is formed in the transition between collar 6a and lateral surface 7a.

This configuration can also be laser-welded without welding allowance, specifically as described above and thus also with simultaneous filling of the root area of the gap 16a. In this way, even with initial line contact, a weld is formed having a weld depth that could not be formed without weld allowance in conventional MIG or MAG welded support members.

In the two exemplary embodiments described above, the lateral surface 7, 7a of the bushing 4, and thus the joint of the bushing 4, protrudes from the joint 12, 12a of the collar 6, 6a, so that a fillet 17, 17a is formed in the transition. The bushing 4, 4a therefore extends through the respective recess. The lateral surfaces 7, 7a of the bushings 4, 4a form a weld pool support for the welding process described above.

According to a further exemplary embodiment, it can be provided that the joint 12b of the collar 6b ends flush with the joint 12b of the bushing 4b (see FIG. 6).

FIGS. 7 and 8 show modifications in relation to the design of the lateral surface 7c of a bushing 4c and a flared collar 6d. Typically, these embodiments are not combined with one another. The lateral surface 7c of the bushing 4c includes three spacers 18, 18.1, 18.2 in the form of rib-like thickenings distributed uniformly on its circumference; this also applies to the second lateral surface 7.1c. By arranging spacers 18, 18.1, 18.2, a defined gap can be set between a receptacle formed by a collar (not shown in this figure) and the lateral surface 7c of the bushing 4c. FIG. 8 shows the same in another exemplary embodiment, in which the collar 6d is designed having spacers 19, 19.1, 19.2 instead of the bushing 4d.

If these two embodiment types are combined, the thickenings 18, 18.1, 18.2, 19, 19.1, 19.2 can engage in one another, as a result of which both components are engaged with one another in a torque-locking manner.

FIG. 9 shows an alternative type of fastening of a differently designed bushing 4e on a support member 1.1. On the bearing shown at the bottom in this figure, it is provided that a first shell 5.1b, pointing counter to the direction of travel, has a recess which has a flared collar 6e, which is formed conical, here in the form of a truncated cone, and into which the lateral surface 7e of the bushing 4e, is mounted as described above for the other exemplary embodiments. It is provided that the bushing 4e is connected to the collar 6e by means of laser welding. The connection of the bushing 4e to the shell 5.1b corresponds to that described for the exemplary embodiment of FIGS. 1 to 4.

At the opposite end of the bushing 4e, it is only held in a recess in the shell 5b. This does not have a flared collar. Instead, the bushing 4e has a step-like stop 20, using which it is supported on the shell 5a in the direction of travel (x-direction) and at the same time is also mounted in a form-fitting manner in the recess in the y-direction.

FIG. 10 shows another support member 21. This is designed as a single shell. The support member 21 has a hat-shaped profile in cross section. Ultimately, the support member 21 corresponds to the shell 5 of the first exemplary embodiment. A recess is introduced into its wall Wb, which corresponds to that of the exemplary embodiment in FIGS. 1 to 4 in the wall W of the shell 5. A bushing 4f engages in this recess and is laser-welded to the collar 6f, as described for the exemplary embodiment of FIGS. 1 to 4. The formfitting and friction-locked connection of the bushing 4f to the collar 6f of the support member 21 ensures that the force is introduced as intended, without the bushing 4f requiring a second bearing point in relation to its longitudinal extension. FIG. 11 shows a cross section through the bushing 4f with the support member 21.

FIG. 12 shows a further exemplary embodiment of the possibility of connecting a bushing 4g to the wall Wc of a support member 22, which in the exemplary embodiment in FIG. 12 is also designed as a single shell. In this design, the collar 6g protrudes from the joint of the bushing 4g. Laser welding between the collar 6g and the bushing 4g takes place in the same way as was done for the exemplary embodiments described above.

A connection of the bushing 4g to the collar 6g of the support member 22, in which the collar 6g protrudes in relation to the joint of the bushing 4g, can of course also be carried out in the case of two-shell support members.

FIG. 13 shows another support member 23. The support member 23 has a two-shell structure and comprises an upper shell 24 and a lower shell 25. Both shells 24, 25 are structured in three dimensions. The two shells 24, 25 are connected to one another circumferentially at their folded mounting flanges (see also FIG. 14). The support member 23 is an axle support member. The two shells 24, 25 are connected to one another by bushings 4h bridging the distance between the shells 24, 25. The bushings 4h are connected to the shells 24, 25 in the same way as described above for the first exemplary embodiment, as shown in the partial section through the support member 23 in FIG. 14. As can be seen from the perspective view in FIG. 13, the bushing connections, i.e.: the collars 6g flared outwards in the illustrated exemplary embodiment, are each in a structure-reinforcing impression 26. In the illustrated embodiment, the inner wall of the collars 6g contacts the complementary lateral surface of the bushing 4h via a surface section. Although in the illustrated embodiment the two joining partners—bushings 4h and collar 6g—are welded together (the weld is not shown in the figure), it is clear that such a design is also suitable for adhesively bonding the bushing with the two shells 24, 25.

The bushings 4h are used on the support member 23 to connect chassis components.

A section of FIG. 15 shows a further support member 27, which is also constructed in two shells. The two shells 28, 29 are connected to one another by a bushing 4i. Both shells 28, 29 are structured, as can be seen in FIG. 15. The bushing 4i is connected to each shell 28, 29 in the same way as described above for the support member 23 with its bushings 4h.

FIG. 16 shows a further two-shell support member 30 in an end view, the two shells 31, 32 of which are connected to one another by a bushing 4j. The bushing 4j is connected to the collars 6h flared outward from one wall in each case, as is described above for the support members 23 and 27. The two shells 31, 32 are identical in the illustrated exemplary embodiment. At their butt joints, these are welded together, typically laser welded.

The invention has been described on the basis of exemplary embodiments. Numerous further embodiments which are to be placed under protection, without departing from the scope of the invention described in the claims, are apparent to a person skilled in the art, without these having to be explained in greater detail in the context of these explanations.

### LIST OF REFERENCE NUMERALS

1, 1.1 support member
2, 2.1 crash element
3, 3.1 base plate
4, 4a . . . 4j bushing
5, 5.1, 5a, 5a.1, 5b, 5b.1 shell
6, 6.1, 6a . . . 6h collar
7, 7.1, 7a, 7b, 7c, 7.1c lateral surface
8 threaded section
9 support section
10 radius
11 plane
12, 12a joint of the collar
12′, 12′a joint of the bushing
13 bead
14 bead
15 surface contact
15′ line contact
16, 16a gap
17, 17a fillet
18, 18.1, 18.2 spacer
19, 19.1, 19.2 spacer
20 stop
21 support member
22 support member
23 support member
24 upper shell
25 lower shell
26 impression
27 support member
28 shell
29 shell
30 support member
31 shell
32 shell
α taper angle of the lateral surface of the bushing
β taper angle of the collar
S leg
SN weld seam
W, W′, Wa, Wb, Wc wall

1. A motor vehicle support member (1) having a structured shell (5, 5.1, 5a, 5a.1, 5b, 5b.1; 24, 25; 28, 29; 31, 32) having a wall (W, W′, Wa, Wb, Wc), into which wall (W, W′, Wa, Wb, Wc) a recess is introduced, and having a bushing (4, 4a . . . 4j) held in the recess of the wall (W, W′, Wa, Wb, Wc) for accommodating and/or mounting a further component that connectible thereon, characterized in that the recess has a conically formed collar (6, 6a . . . 6h), which is flared in the longitudinal direction of the bushing (4, 4a . . . 4j) and thus protrudes from the plane of the wall (W, W′, Wa, Wb, Wc) of the shell (5, 5.1; 5a, 5a.1, 5b, 5b.1; 24, 25; 28, 29; 31, 32), as a receptacle for the bushing (4, 4a . . . 4j), on which the bushing (4, 4a . . . 4j) is fixed, wherein the bushing (4, 4a . . . 4j), in the section in which it is fixed on the collar (6, 6a . . . 6h), includes a conical lateral surface (7, 7.1).

2. The support member according to claim 1, characterized in that the design of the angle of inclination of the conical lateral surface (7) and the contour of the flared collar (6, 6a . . . 6h) are coordinated in such a way that with a welded connection between the collar (6, 6a . . . 6h) and the bushing (4, 4a . . . 4j) a gap (16, 16a) that opens with respect to the gap width is formed on the side facing away from the welding energy.

3. The support member according to claim 1 or 2, characterized in that the shell (5) has legs (S) which are spaced apart from one another by the wall (W, Wa, Wb, Wc).

4. The support member according to any one of claims 1 to 3, characterized in that the bushing (4, 4a . . . 4j) has line contact with the collar (6, 6a . . . 6h) before welding or contacts it with a contact section over a surface, wherein the extension of the contact surface in the contact section in the direction of the longitudinal extension of the bushing (4, 4a . . . 4j) is not greater than twice the material thickness of the collar (6, 6a . . . 6h).

5. The support member according to any one of claims 1 to 4, characterized in that the joint of the flared collar (6, 6a . . . 6h) is spaced apart from the front end of the bushing (4, 4a . . . 4j).

6. The support member according to any one of claims 1 to 5, characterized in that the base surface of the conical collar (6, 6a . . . 6h) is round, in particular circular.

7. The support member according to any one of claims 1 to 6, characterized in that the bushing (4, 4a . . . 4j) is fixed on the collar (6, 6a . . . 6h) by laser welding.

8. The support member according to claim 7, characterized in that the welding has been carried out in such a way that the weld seam formed extends into the gap (16, 16a) and as a result a gap base is formed in the gap (16, 16a), by which the opposing surfaces of the collar (6, 6a . . . 6h, 6.1) and bushing (4, 4a . . . 4j) are spaced apart, wherein the minimum gap width formed by the gap base is sufficiently large for a corrosion-inhibiting coating to reach the gap base.

9. The support member according to any one of claims 1 to 8, characterized in that the collar (6, 6a . . . 6h, 6.1) contacts the bushing (4, 4a . . . 4j) on the circumference.

10. The support member according to any one of claims 1 to 8, characterized in that the bushing (4, 4a . . . 4j), in its area in which it contacts the collar (6, 6a . . . 6h), on its lateral surface (7c, 7c.1) includes spacers (18, 18.1, 18.2) in the form of thickenings extending in the longitudinal direction of the bushing (4, 4a . . . 4j), using which it contacts the collar (6, 6a . . . 6h) and/or that the collar (6, 6a . . . 6f), in the area in which it contacts the lateral surface (7c, 7c.1) of the bushing (4, 4a . . . 4j), includes spacers (19, 19.1, 19.2) extending in the longitudinal direction of the bushing (4, 4a . . . 4j) in the form of thickenings or embossings, using which it contacts the lateral surface (7) of the bushing (4, 4a . . . 4j), so that between the bushing (4, 4a . . . 4j) and the collar (6, 6a . . . 6h), a gap results in the areas between the spacers (18, 18.1, 18.2, 19, 19.1, 19.2).

11. The support member according to any one of claims 1 to 10, characterized in that the support member (1) includes, in addition to the shell (5, 5a, 5b), a second shell (5.1, 5a.1, 5b.1), which second shell (5.1, 5a.1, 5b.1) includes a recess aligned with the recess of the first shell (5, 5a, 5b) with respect to its longitudinal axis.

12. The support member according to claim 11, characterized in that the recesses in the walls (W, W′, Wa, Wb, Wc) of the shells (5, 5a, 5b, 5.1, 5a1, 5b.1) have a conically formed collar (6, 6a . . . 6h, 6.1), flared in the longitudinal direction of the bushing (4, 4a . . . 4j), the bushing (4, 4a . . . 4j), in the areas in which it is fixed to the collars (6, 6a . . . 6h, 6.1), has a conical lateral surface (7, 7.1) complementary and in the same direction to the respective collar (6, 6a . . . 6h, 6.1) and the taper angles (β) of the receptacles formed by the collar (6, 6a . . . 6h, 6.1) are not smaller than the respective taper angles (α) formed by the lateral surface (7, 7.1) of the bushing (4, 4a . . . 4j) and the directions in which the collars (6, 6a . . . 6h, 6.1) are flared are in opposite directions.

13. The support member according to claim 12, characterized in that the bushing (4, 4a . . . 4j) extends through the other recess and makes contact at least in sections with its lateral surface (7, 7.1).

14. The support member according to any one of claims 11 to 13, characterized in that the first shell (5, 5a, 5b) is a hat profile and the second (5.1, 5a.1, 5b.1) is a closing plate complementary thereto.

15. The support member according to any one of claims 1 to 14, characterized in that the support (1) is a bumper cross beam and the bushing (4, 4a . . . 4j) is a towing sleeve for connecting a towing eye.

16. A method for producing a support member (1) according to any one of claims 1 to 15, comprising the following steps:
providing a shell (5, 5a, 5b) having two legs spaced apart by a wall (W, W′, Wa, Wb, Wc),
introducing at least one recess into the wall (W, W′, Wa, Wb, Wc) and forming a flared collar (6, 6a . . . 6h) enclosing the recess,
installing a bushing (4, 4a . . . 4j) engaging in the recess, and
materially bonding the bushing (4, 4a . . . 4j) with the collar (6, 6a . . . 6h, 6.1) of the shell (5, 5a, 5b).

17. The method according to claim 16, characterized in that the recess is produced by stamping and the flared collar (6, 6a . . . 6h) is produced by deep-drawing in a pressing tool.

18. The method according to claim 16 or 17, characterized in that a second shell (5.1, 5a.1, 5b.1) is provided having a recess aligned with the longitudinal axis of the recess of the first shell (5, 5a, 5b), into which the bushing (4, 4a . . . 4j) engages at the recess or through which it extends and that before connecting the two shells (5, 5a, 5b, 5.1, 5a1, 5b.1), the bushing (4, 4a . . . 4j) is welded to one of the two shells (5, 5a, 5b, 5.1, 5a1, 5b.1).

19. The method according to claim 18, characterized in that the bushing (4, 4a . . . 4j) is positioned and held between the two shells (5, 5a, 5b, 5.1, 5a.1, 5b.1), with a section engaging in each recess, and then the bushing (4, 4a . . . 4j) is laser welded to the shells (5, 5a, 5b, 5.1, 5a.1, 5b.1) in such a way that molten metal penetrates through the joint between the collar (6, 6a . . . 6h) and the lateral surface of the bushing (4, 4a . . . 4j) into an opening gap (16, 16a) on the side facing away from the laser beam and forms a gap base therein.
